(19) United States
(12) Patent Application Publication
(10) Pub. No.: US 2018/0067192 A1
(43) Pub. Date: Mar. 8, 2018

(54) Apparatus and Method for Updating at Least One Sensor Device Arranged in a Vehicle, and Sensor for a Vehicle

(71) Applicant: Robert Bosch GmbH, Stuttgart (DE)

(72) Inventor: Marlon Ramon Ewert, Untergruppenbach (DE)

(21) Appl. No.: 15/697,534

(22) Filed: Sep. 7, 2017

(30) Foreign Application Priority Data
Sep. 7, 2016 (DE) 10 2016 216 983.1

(51) Int. Cl. G01S 7/40; G01S 13/93; G01S 7/52

(52) U.S. Cl. CPC G01S 7/4004; G01S 13/931; G01S 2013/9321; G01S 2007/4091; G01S 7/52004

(57) ABSTRACT

The disclosure relates to an apparatus for updating at least one sensor device arranged in a vehicle. In this case, the apparatus is part of the at least one sensor device or is connectable or connected to the at least one sensor device so as to have data transmission capability. The apparatus has at least one communication interface for transmitting update data for updating the at least one sensor device from a collation device arranged outside the at least one sensor device to the at least one sensor device.

This application claims priority under 35 U.S.C. § 119 to application no. DE 10 2016 216 983.1, filed on Sep. 7, 2016 in Germany, the disclosure of which is incorporated herein by reference in its entirety.

### BACKGROUND

The disclosure is based on an apparatus or a method. The subject matter of the present disclosure is also a computer program.

Vehicles can have sensors in driver assistance systems, airbag systems and the like, for example, inter alia. Usually, such sensors can increasingly be programmed in a production process, this also being able to be referred to as EOL (end of line).

### SUMMARY

Against this background, the approach presented here presents a method, additionally an apparatus that uses this method, and finally a corresponding computer program according to disclosure. The measures cited in the embodiments allow advantageous developments and improvements for the apparatus.

According to embodiments, it is particularly possible to update a vehicle sensor in an already used or fitted state, for example by means of wireless data transmission. Put another way, it is particularly possible to realize programming or calibration of a sensor in a vehicle, for example via a car-to-car communication interface or car-to-infrastructure communication interface.

Advantageously, it is therefore particularly possible to update, program or calibrate sensors, even if they are already installed in the vehicle. Hence, it is possible, by way of example, to correct outdated or obsolete EOL (end of line) programming in sensors, inter alia, without this requiring vehicles to be brought to a workshop. Furthermore, sensors can particularly be provided with improved programming, which allows a functionality of the applicable sensors to be extended and additionally or alternatively improved, for example.

In comparison with sensors programmed as part of a production process, wherein it is particularly possible for sensor-specific and manufacturer-specific sensor data to be written to the sensor by means of a communication link to the sensor and then to remain in a one time programmable (OTP) memory in the sensor, for example, and not to be altered again during a sensor life, for example, it is also possible, according to embodiments, for sensor-specific data that can directly influence the sensor behavior during operation of the sensor, e.g. calibration data, to be written to the sensor particularly even after startup and in the installed state without a visit to a workshop, for example. Hence, it is possible for erroneously written data in the sensor to be corrected and additionally or alternatively for obsolete data to be updated, for example.

An apparatus for updating at least one sensor device arranged in a vehicle is presented, wherein the apparatus is part of the at least one sensor device or is connectable or is connected to the at least one sensor device so as to have data transmission capability, wherein the apparatus has at least the following feature:

A communication interface for transmitting update data for updating the at least one sensor device from a collation device arranged outside the at least one sensor device to the at least one sensor device.

The vehicle may be a motor vehicle, particularly a land vehicle, watercraft or aircraft, for example a road-based motor vehicle, such as an automobile, a motorcycle, a truck or another commercial vehicle, for example. The update data can represent calibration data and additionally or alternatively programming data. Put another way, the update data may be designed to be used for calibrating, programming and additionally or alternatively reprogramming the at least one sensor device.

To this end, the apparatus can have at least one computation unit for processing signals or data, at least one memory unit for storing signals or data, at least one interface to a sensor or an actuator for reading in sensor signals from the sensor or for outputting data signals or control signals to the actuator, and/or at least one communication interface for reading in or outputting data that are embedded in a communication protocol. The computation unit may be a signal processor, a microcontroller or the like, for example, wherein the memory unit may be a flash memory, an EPROM or a magnetic memory unit. The communication interface may be designed to read in or output data wirelessly and/or by wire, wherein a communication interface that can read in or output line-based data can read in these data, for example electrically or optically, from an applicable data transmission line or can output said data to an applicable data transmission line.

In the present case, an apparatus can be understood to mean an electrical device that processes sensor signals and takes this as a basis for outputting control signals and/or data signals. The apparatus can have an interface that may be in hardware and/or software form. In the case of a hardware form, the interfaces may be part of what is known as a system ASIC, for example, which includes a wide variety of functions of the apparatus. However, it is also possible for the interfaces to be separate, integrated circuits or to consist, at least in part, of discrete components. In the case of a software form, the interfaces may be software modules that are present on a microcontroller in addition to other software modules, for example.

According to one embodiment, at least the communication interface may be embodied as part of the at least one sensor device. Such an embodiment affords the advantage that standing surface area and installation space can be saved, the at least one sensor device additionally being able to be embodied so as to have at least in part autonomous communication capability for updating.

Alternatively, at least the communication interface may be arranged outside the at least one sensor device in the vehicle. Additionally or alternatively, the communication interface may be embodied as part of a controller arranged in the vehicle. Such an embodiment affords the advantage that it is also possible for multiple sensor devices to be updated by means of a communication interface when required.

The communication interface may also be designed to transmit data wirelessly and additionally or alternatively by wire. Such an embodiment affords the advantage that complexity and costs can be lowered, with an application-specific configuration of the communication interface also being able to be made possible.

Further, the communication interface may be designed to provide inventory data of the at least one sensor device to the collation device for collation of the inventory data with comparison data. The inventory data or the comparison data can in this case represent the update data on the basis of a comparison of time stamps of said inventory data and comparison data. Such an embodiment affords the advantage that the at least one sensor device can be updated using the most up-to-date or more up-to-date data.

In addition, the communication interface may be designed to query or request the update data from the collation device. Such an embodiment affords the advantage that an update can be initiated by the apparatus and additionally or alternatively the at least one sensor device itself.

In particular, the communication interface may be designed to institute or set up a data transmission with the collation device when a maximum communication range between the communication interface and the collation device has not been reached. Such an embodiment affords the advantage that an update of the at least one sensor device can be made possible automatically when a collation device is in range.

A sensor for a vehicle is also presented, wherein the sensor has the following features: an embodiment of the apparatus cited above, wherein the apparatus is arranged in the vehicle;

at least one sensor device arranged in the vehicle; and
a collation device arranged outside the at least one sensor device, wherein the at least one sensor device is connectable or connected to the collation device via the communication interface of the apparatus so as to have data transmission capability.

In conjunction with the sensor, it is therefore possible to employ or use an embodiment of the apparatus cited above in order to cause or allow an update of the at least one sensor device using update data from the collation device.

According to one embodiment, the collation device may be embodied as a further sensor device that may be arranged in the vehicle or in another vehicle. The further sensor device and the at least one sensor device may be embodied so as to be of the same design, of the same type or similar in relation to one another. In this case, the collation device may be embodied so as to have data transmission capability and may additionally or alternatively have the further sensor device and optionally a further instance of an embodiment of the apparatus for updating cited above. Such an embodiment affords the advantage that reciprocal updating of sensor devices can be made possible.

Additionally or alternatively, the collation device may be embodied as a data management device arranged outside the vehicle. The data management device can have a server or another database or may be embodied by means of what is known as a cloud. Such an embodiment affords the advantage that a central reference can be provided for updates.

A method for updating at least one sensor device arranged in a vehicle is further presented, wherein the method has at least the following step:

transmission of update data for updating the at least one sensor device from a collation device arranged outside the at least one sensor device to the at least one sensor device by means of a communication interface.

This method may, by way of example, be implemented in software or hardware or in a mixture of software and hardware, for example in an apparatus or a controller. The method can be carried out at least by means of an embodiment of the apparatus cited above, wherein the apparatus is designed to perform, actuate or implement the steps of a variant of the method presented here in applicable devices.

Further, an embodiment of the method proposed here is conceivable in which there is provision for a step of performance of an update of the at least one sensor device using the update data transmitted in the step of transmission. Such an embodiment can implement the approach presented here quickly, inexpensively and efficiently.

Also advantageous is a computer program product or computer program having a program code that may be stored on a machine-readable carrier or storage medium such as a semiconductor memory, a hard disk memory or an optical memory and is used for performing, implementing and/or actuating the steps of the method according to one of the embodiments described above, particularly when the program product or program is executed on a computer or an apparatus.

### BRIEF DESCRIPTION OF THE DRAWINGS

Exemplary embodiments of the approach presented here are depicted in the drawings and explained in more detail in the description below. In the drawings:

FIG. 1 shows a schematic depiction of a vehicle and of a sensor according to an exemplary embodiment;

FIG. 2 shows a schematic depiction of a vehicle and of a sensor according to an exemplary embodiment;

FIG. 3 shows a schematic depiction of a vehicle, of another vehicle and of a sensor according to an exemplary embodiment; and

FIG. 4 shows a flowchart for a method for updating according to an exemplary embodiment.

### DETAILED DESCRIPTION

Before exemplary embodiments of the approach presented here are discussed in more detail below, a brief explanation of backgrounds and principles in the relevant field of vehicle sensors and vehicle communication will first of all be provided.

What is known as car-to-car communication (also referred to as car2car or C2C) is understood to mean an interchange of information and data between motor vehicles. The aim of this data interchange is to report critical or dangerous situations to a driver in good time, for example. Moreover, vehicle-specific data can be interchanged between the vehicles via such an interface. Relevant vehicles collect data, such as ABS interventions, steering angle, position, direction and speed, for example, and send these data to other road users by radio (WLAN, UMTS, etc.). In this case, a visual range of the driver can be extended virtually using electronic means. Car-to-infrastructure communication (also referred to as C2I) is understood to mean an interchange of data between a vehicle and a surrounding infrastructure, e.g. light signal systems. The cited types of communication are based on an interaction of sensors of the various traffic partners and use methods of communication technology for interchanging information. Vehicles for highly automated driving can use car-to-car communication systems to interchange data among one another.

Driver assistance systems are electronic supplementary devices in motor vehicles for assisting the driver in particular driving situations. The foremost consideration in this context are often safety aspects, but also an increase in driving comfort. A further aspect is an improvement in economy. Driver assistance systems intervene semiautonomously or autonomously in propulsion, control (e.g. accelerator, brake) or signaling devices of the vehicle or use suitable man/machine interfaces to warn the driver of or during critical situations. At present, most driver assistance systems are designed such that responsibility ultimately remains with the driver. Various types of ambient sensors are used for driver assistance systems, including ultrasound (parking aid), radar (lane change assistant, automatic distance alert), lidar (blind spot monitoring, automatic distance alert, distance control, impact warning and braking assistant) and/or camera (lane departure warning, road sign recognition, lane change assistant, blind spot monitoring, emergency braking system for pedestrian protection).

For the purpose of detecting pedestrian accidents, it is possible for sensors installed in a vehicle bumper to be used. By way of example, systems that are based on two or more acceleration sensors (PCS—pedestrian collision sensor) are customary. In addition, pressure-tube-based systems (PTS—pressure tube sensor) are available. Both in the case of the acceleration systems and in the case of the pressure-tube-based systems, an impact by an object in a relevant region of the bumper results in a signal rise in the detecting sensors. An amplitude of the detected signals is dependent on the mass and speed of the impinging object, inter alia. For the purpose of recognizing head-on collisions, acceleration sensors are usually used. These are arranged in a central controller and additionally along a flexible crossmember of the vehicle, for example. For the purpose of recognizing a side impact, either pressure sensors or acceleration sensors are usually used. These are arranged on a B, C or D pillar of the vehicle (acceleration sensors) or in a vehicle door (pressure sensors), for example. The amplitude of the detected signals is dependent on the mass and the speed of the impinging object, inter alia. The signals that are output by the sensors are processed further using algorithms within an airbag controller, for example. When an algorithm recognizes that an impact has taken place, active restraining means (e.g. airbag) in or outside the vehicle are activated on the basis of a trigger decision in order to protect vehicle occupants and pedestrians in the event of an impact.

In the description of favorable exemplary embodiments of the present disclosure below, like or similar reference symbols are used for the elements having a similar action that are depicted in the various figures, a repeated description of these elements being dispensed with.

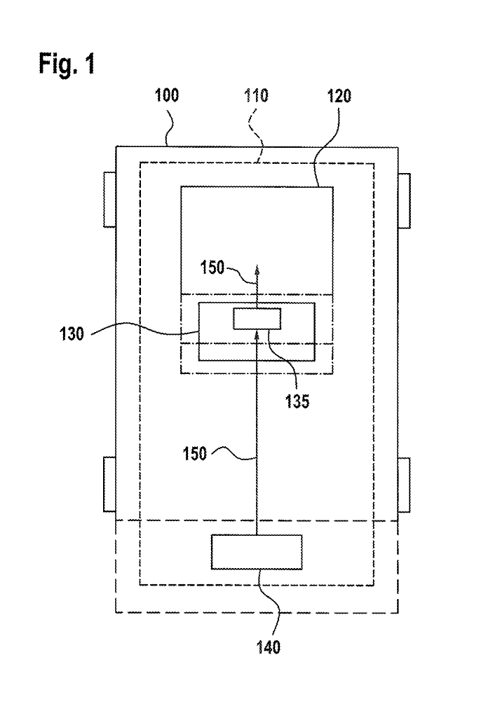

FIG. 1 shows a schematic depiction of a vehicle 100 and of a sensor 110 according to an exemplary embodiment. The vehicle 100 is a motor vehicle, particularly an automobile or the like. The sensor 110 is at least partly arranged in the vehicle 100.

According to the depicted in FIG. 1, the sensor 110 has, by way of example, merely a sensor device 120, which is arranged in the vehicle 100, an apparatus 130 for updating the sensor device 120, or a communication interface 135, which is arranged in the vehicle 100, and a collation device 140 arranged outside the sensor device 120.

The sensor device 120 represents a vehicle sensor of the vehicle 100 for a driver assistance function, a safety function or the like, for example. The collation device 140 is, according to one exemplary embodiment, embodied as a further sensor device arranged in the vehicle 100. According to another exemplary embodiment, the collation device 140 is embodied as a data management device arranged outside the vehicle 100. Hence, the collation device 140 may, according to a respective exemplary embodiment, be arranged in the vehicle 100 or outside the vehicle 100.

The update apparatus 130 is connectable or connected to the sensor device 120 so as to have data transmission capability. According to one exemplary embodiment, the update apparatus 130 is part of the sensor device 120 and connectable or connected to the sensor device 120 so as to have data transmission capability.

The update apparatus 130 has a communication interface 135. The communication interface 135 is designed to transmit update data 150 for updating the sensor device 120 from the collation device 140 to the sensor device 120. According to one exemplary embodiment, at least the communication interface 135 of the update apparatus 130 is embodied as part of the sensor device 120. According to another exemplary embodiment, at least the communication interface 135 of the update apparatus 130 is arranged outside the sensor device 120 in the vehicle 100.

The sensor device 120 is connectable or connected to the collation device 140 via or by means of the communication interface 135 of the apparatus 130 so as to have data transmission capability. The update data 150, which are transmittable or transmitted from the collation device 140 to the sensor device 120 using the communication interface 135, represent calibration data, programming data or the like, for example.

A connection having data transmission capability between the sensor device 120 and the communication interface 135 is realized by wire or wirelessly, wherein a connection having data transmission capability between the communication interface 135 and the collation device 140 is realized by wire or wirelessly. The sensor device 120 is connectable or connected to the collation device 140 via or by means of the communication interface 135 of the apparatus 130, for example in a wireless manner, so as to have data transmission capability. Hence, the communication interface 135 is designed to transmit at least the update data 150 wirelessly.

The communication interface 135 may, according to one exemplary embodiment, further be designed to provide inventory data of the sensor device 120 to the collation device 140 for collation of the inventory data with comparison data. In this case, either the inventory data or the comparison data then represent the update data 150 on the basis of a comparison of time stamps of said inventory data and comparison data. In this case, the communication interface 135 may also be designed to query or request the update data 150 from the collation device 140 automatically or according to a default specification.

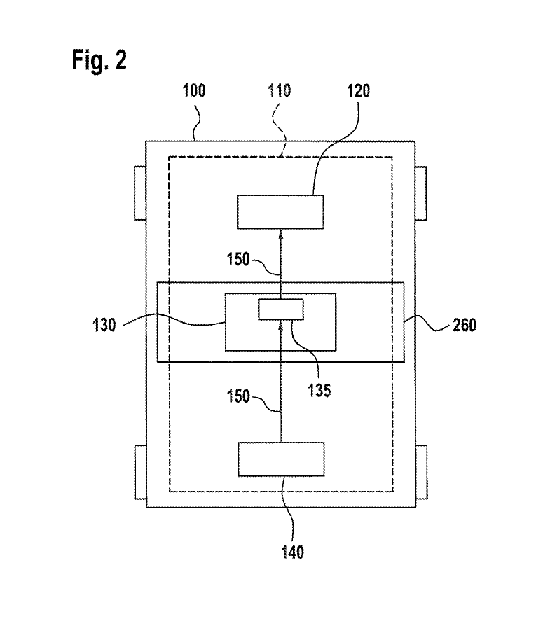

FIG. 2 shows a schematic depiction of a vehicle 100 and of a sensor 110 according to one exemplary embodiment. In this case, the sensor 110 corresponds to the sensor shown in FIG. 1 with the exception that the update apparatus 130 is arranged outside the sensor device 120 in the vehicle 100. To be more precise, the update apparatus 130 is embodied as part of a controller 260 arranged in the vehicle 100. The collation device 140 is arranged in the vehicle 100 and represents a further sensor device, for example.

A connection having data transmission capability between the sensor device 120 and the communication interface 135 in the controller 260 is realized by wire or wirelessly, wherein a connection having data transmission capability between the communication interface 135 in the controller 260 and the collation device 140 is realized by wire or wirelessly.

According to one exemplary embodiment, at least the communication interface 135 may be arranged outside the sensor device 120 in the vehicle 100 and may additionally or alternatively be embodied as part of the controller 260.

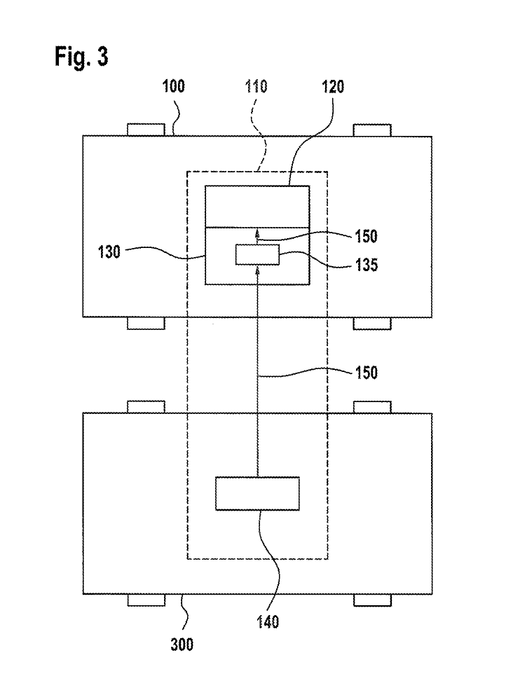

FIG. 3 shows a schematic depiction of a vehicle 100, of another vehicle 300 and of a sensor 110 according to one exemplary embodiment. In this case, the sensor 110 corresponds to the sensor shown in FIG. 1 and FIG. 2 with the exception that the collation device 140 is embodied as a further sensor device that is arranged in the other vehicle 300. Hence, the update data 150 are transmitted between the vehicle 100 and the other vehicle 300. The sensor 110 has a first part that is arranged in the vehicle 100 and a second part that is arranged in the other vehicle 300.

According to one exemplary embodiment, the collation device 140 can have the further sensor device, which may be similar to the sensor device 120, and a further update apparatus.

According to one exemplary embodiment, the communication interface 135 of the update apparatus 130 is designed to institute or set up a data transmission with the collation device 140 when a maximum communication range between the communication interface 135 and the collation device 140 has not been reached.

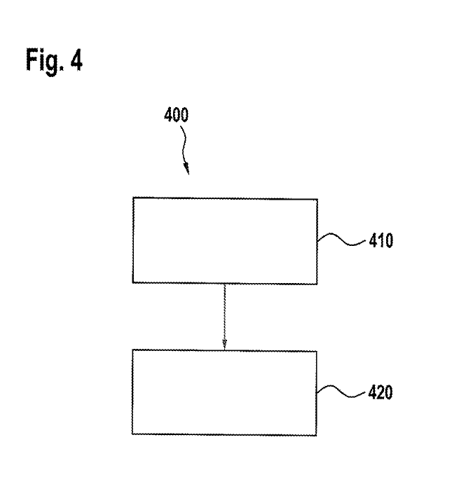

FIG. 4 shows a flowchart for a method 400 for updating according to one exemplary embodiment. The method 400 can be carried out in order to update at least one sensor device arranged in a vehicle. In this case, the method 400 can be carried out in conjunction with or using the sensor and/or the update apparatus from one of FIGS. 1 to 3.

The method 400 for updating has a step 410 of transmission of update data for updating the at least one sensor device from a collation device arranged outside the at least one sensor device to the at least one sensor device by means of a communication interface.

The method 400 for updating also has a step 420 of performance of an update of the at least one sensor device using the update data transmitted in step 410 of transmission.

With reference to FIGS. 1 to 4, exemplary embodiments and advantages are explained once again below in summary and in other words.

The sensor device 120 can, according to one exemplary embodiment, be updated, calibrated and/or reprogrammed remotely. This involves resorting to radio links such as car-to-car and/or car-to-infrastructure, for example, and/or a cloud for the communication interface 135.

In a first variant embodiment, the sensor device 120 uses the communication interface 135 or directly uses a radio and/or cable link to communicate with a further sensor as collation device 140, wherein content of sensor memories is collated between the sensor device 120 and the collation device 140. In this case, the sensor device 120 and the collation device 140 may be arranged either in the same vehicle 100 or in different vehicles 100 and 300 within a minimum distance M, the sensor device 120 and the further sensor or the collation device 140 being of the same design or similar. If the sensor device 120 and the collation device 140 are arranged inside different vehicles 100 and 300, car-to-car communication is resorted to for the data interchange by means of the communication interface 135. If the sensor device 120 and the collation device 140 are arranged inside the same vehicle 100, then either wireless data transmission, for example by means of car-to-car, or optionally wire data transmission is resorted to for the data interchange between the sensor device 120 and the collation device 140 by means of the communication interface 135. If a sensor memory of one of the two, i.e. the sensor device 120 or the collation device 140, is more up to date than the sensor memory of the other, then the more up-to-date memory content is automatically transmitted as update data 150. At the end of the transmission, the same up-to-date sensor memory content, for example, is on the sensor device 120 and the collation device 140 on account of the transmission of the update data 150.

In a second variant embodiment, the sensor device 120 directly uses a radio link by means of the communication interface 135 to communicate with a collation device 140, for example of a sensor manufacturer, that is arranged remotely from the vehicle 100 and/or centrally, wherein content of a sensor memory is interchanged between the sensor device 120 and the collation device 140, for example using car-to-infrastructure and/or via a cloud, by means of the communication interface 135. If the sensor memory on the sensor device 120 is older than the sensor memory stored in the collation device 140 by the sensor manufacturer, then the more up-to-date sensor memory is automatically transmitted as an update signal 150 from the collation device 140 to the sensor device 120 via the communication interface 135. Conversely, a new memory content is not transmitted to the sensor device 120 if the memory content or the inventory data of the sensor device 120 is or are already up to date.

According to one exemplary embodiment, the communication interface 135 is embodied as a radio interface in the at least one sensor device 120. It is also conceivable for the communication interface 135 to be realized as a car-to-car or car-to-infrastructure communication interfaces in the controller 260. In this case, it is also possible for the at least one sensor device 120 to be programmed indirectly via the controller 260. A data interchange between the at least one sensor device 120 and the collation device 140 can be effected particularly via the controller 260 in this case, wherein programming of the at least one sensor device 120 is effected after the data interchange between the controller 260 or the controller 260 and the collation device 140 by the controller 260. In this case, the programming of the at least one sensor device 120 can be effected either directly via cable links and/or radio links between the controller 260 and the at least one sensor device 120.

When an exemplary embodiment comprises an “and/or” combination between a first feature and a second feature, this is intended to be read to mean that the exemplary embodiment has both the first feature and the second feature according to one embodiment and either only the first feature or only the second feature according to a further embodiment.

What is claimed is:

1. An apparatus for updating at least one sensor device arranged in a vehicle, the apparatus comprising:
a communication interface configured to update the at least one sensor device by transmitting update data from a collation device arranged outside the at least one sensor device to the at least one sensor device,
wherein the apparatus is one of (i) part of the at least one sensor device and (ii) at least one of connectable and connected to the at least one sensor device so as to have data transmission capability.

2. The apparatus according to claim 1, wherein the at least the communication interface is embodied as part of the at least one sensor device.

3. The apparatus according to claim 1, wherein at least the communication interface is at least one of (i) arranged outside the at least one sensor device in the vehicle and (ii) embodied as part of a controller arranged in the vehicle.

4. The apparatus according to claim 1, wherein the communication interface is configured to transmit data at least one of wirelessly and by wire.

5. The apparatus according to claim 1, the communication interface being further configured to:
provide inventory data of the at least one sensor device to the collation device for collation of the inventory data with comparison data, wherein one of the inventory data and the comparison data represent the update data based on a comparison of time stamps of the inventory data and the comparison data.

6. The apparatus according to claim 1, wherein the communication interface is further configured to:
one of query and request the update data from the collation device.

7. The apparatus according to claim 1, wherein the communication interface is further configured to:
one of institute and set up a data transmission with the collation device when a maximum communication range between the communication interface and the collation device has not been reached.

8. A sensor for a vehicle, the sensor comprising:
at least one sensor device arranged in the vehicle;
a collation device arranged outside the at least one sensor device; and
an apparatus arranged in the vehicle, the apparatus having a communication interface configured to update the at least one sensor device by transmitting update data from the collation device to the at least one sensor device,
wherein the apparatus is one of (i) part of the at least one sensor device and (ii) at least one of connectable and connected to the at least one sensor device so as to have data transmission capability, and
wherein the at least one sensor device is at least one of connectable and connected to the collation device via the communication interface of the apparatus so as to have data transmission capability.

9. The sensor according to claim 8, wherein the collation device is embodied as a further sensor device that is one of (i) arranged in the vehicle and (ii) arranged in another vehicle.

10. The sensor according to claim 8, wherein the collation device is embodied as a data management device arranged outside the vehicle.

11. A method for updating at least one sensor device arranged in a vehicle, the method comprising:
updating the at least one sensor device by transmitting update data from a collation device arranged outside the at least one sensor device to the at least one sensor device using a communication interface.

12. The method according to claim 11, further comprising:
performing an update of the at least one sensor device using the transmitted update data.

13. The method according to claim 11, wherein the method is carried out by a non-transitory computer program.

14. The method according to claim 11, wherein the computer program is stored on a machine-readable storage medium.
